(19) United States
(12) Patent Application Publication
(10) Pub. No.: US 2005/0033959 A1
(43) Pub. Date: Feb. 10, 2005

(54) Portable secure information access system, portable storage device and access method for portable secure information

(76) Inventors: Jia-Xin Zheng, Xin-Dian City (TW); Jia-Yan Lu, Ba-De City (TW); Ji-Feng Wu, Yi-Lan City (TW)

Correspondence Address: DUANE MORRIS, LLP;IP DEPARTMENT, ONE LIBERTY PLACE, PHILADELPHIA, PA, 19103-7396, US

(21) Appl. No.: 10/885,887

(22) Filed: Jul. 7, 2004

(30) Foreign Application Priority Data
Jul. 7, 2003 (TW) 92118651

(51) Int. Cl. H04L 9/00

(52) U.S. Cl. 713/169

(57) ABSTRACT

A portable secure information access system is disclosed. The system comprises a portable storage device and a secure access module. The portable storage device comprises a disk partition, in which a secure information is recorded, particularly in a concealed disk partition, and a secure computing module. The secure computing module generates a session key (SK) in accordance with a challenge-response mechanism. The secure access module receives the SK from the secure computing module, encrypting or decrypting the secure information stored in the disk partition in accordance with the SK so as to access the secure information.

### FIELD OF THE INVENTION

The present invention relates to a secure information access system and method; and more particularly to a portable secure information access system, a portable storage device and an access method for portable secure information

### BACKGROUND

The human lifestyle is already facing major changes as a consequence of the popularization of computers and networks. For example, the establishment and management of digital data has already replaced the traditional modes of paper usage, the Internet has already become the best method for people to collect data, and people are performing commercial exchanges using the Internet, such as shopping and investing in stocks, etc. In contrast, due to the influence of information and digitization of human life, related problems concerning network security, protection of privacy of personal data, and authentication of identity, etc., have already become serious problems which require priority solutions.

The problems of network security, protection of privacy of personal data, and authentication of identity can be solved by utilizing secure information, such as keys and personal private data. For example, Internet service providers, before providing network services, can perform authentication of identity by examining personal private data in order to confirm whether or not the operators are legitimate users, or when receiving data they can perform identification of the user's key in accordance with related public-key cryptography technology in order to confirm the user's identity.

However, no effective management mechanism exists for the above-described personal secure information, and the well-known management scheme is for the user to voluntarily store the secure information on the related storage medium, such as a magnetic disk, in order to avoid the possibility that the secure information may be deleted or stolen when other users use the same computer. However, because magnetic disk space is limited, one cannot store a large quantity of private information. Also there is no way to increase the use value. In addition, because there has not yet been established any related mechanism that can protect secure information on a storage medium, other than simply being able to control whether or not one can provide a computer system to access the secure information by means of a switch, in the event that the user loses the storage medium, there still is an opportunity for the secure information on the storage medium to be stolen.

### SUMMARY OF THE INVENTION

A portable secure information access system is disclosed. The system comprises a portable storage device and a secure access module. The portable storage device comprises a disk partition in which to record a secure information and a secure computing module. The secure access module receives a session key (SK) from the secure computing module, encrypting or decrypting the secure information stored in the disk partition in accordance with the SK so as to access the secure information.

A portable storage device comprises a disk partition and a secure computing module. The disk partition records a secure information. The secure computing module generates a session key (SK) in accordance with a challenge-response mechanism.

An access method for portable secure information is disclosed. The access method comprises: generating a session key (SK) in accordance with a challenge-response mechanism; and encrypting and decrypting a secure information in accordance with the SK.

### BRIEF DESCRIPTION OF THE DRAWINGS

FIG. 1 is a schematic drawing showing an exemplary portable secure information access system.

FIGS. 2A and 2B are an operational flow showing an exemplary access method for secure information.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

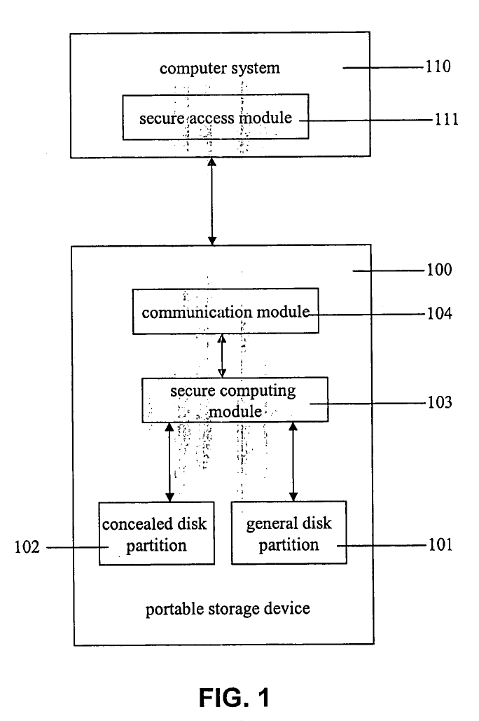

FIG. 1 is a schematic drawing showing an exemplary portable secure information access system.

The portable secure information access system according to this embodiment comprises a portable storage device 100 and a computer system 110 having a secure access module 111. The present invention can be embodied on any form of portable storage medium, such as mobile hard disk or flash memory, or the like.

The portable storage device 100 includes a general disk partition 101, a concealed (first) disk partition 102, a secure computing module 103, and a communication module 104. In the general disk partition 101, general insecure data can be stored therein. In the concealed disk partition 102, related secure information, such as personal secret keys, certificate files, and personal private data, etc., can be stored. In this embodiment for security considerations the disk partition 102 is designed to be concealed, that the concealed disk partition 102 and the secure information therein cannot be detected and examined by the operating system of the computer system 110, and that there is no way to perform access using general file management tools in the computer system 110. Alternatively, the disk partition 102 can be designed as not concealed, but, the secure information in the disk partition 102 must be accessed by means of the mechanism of the present invention in order to achieve the purpose of secure access. Under actually made examples, the concealed disk partition 102 can be specified as 16K-256K or higher. Other than this, the data stored in the general disk partition 101 can be directly accessed by means of the operating system or file management tools in the computer system 110.

The secure computing module 103 can be established in firmware in the portable storage device 100, and it is mainly responsible for computation required for communication with the secure access module 111 in the computer system 110. The communication module 104 is responsible for processing required for communication between the portable storage device 100 and the computer system 110. In some embodiments, the portable storage device 100 can be connected with the computer system 110 by means of a universal serial bus (USB), at which time, the communication module 104 then is responsible for related processing of USB interface communication between the portable storage device 100 and the computer system 110.

The secure access module 111 in the computer system 110 is designed to access secure information in the concealed disk partition 102 and data in the general disk partition 101. In addition, the secure access module 111 also can ensure information security during data transmission between the portable storage device 100 and the computer system 110. The secure access module 111 can obtain a session key (SK) from the secure computing module 103 in accordance with a security mechanism such as a challenge-response mechanism, and furthermore perform encryption and decryption of the secure information in the concealed disk partition 102 in accordance with the session key, in order to securely access the secure information. The challenge-response mechanism can be, for example, a hand-shaking mechanism. The secure transmission mechanism between the secure computing module 103 and the secure access module 111 is explained below.

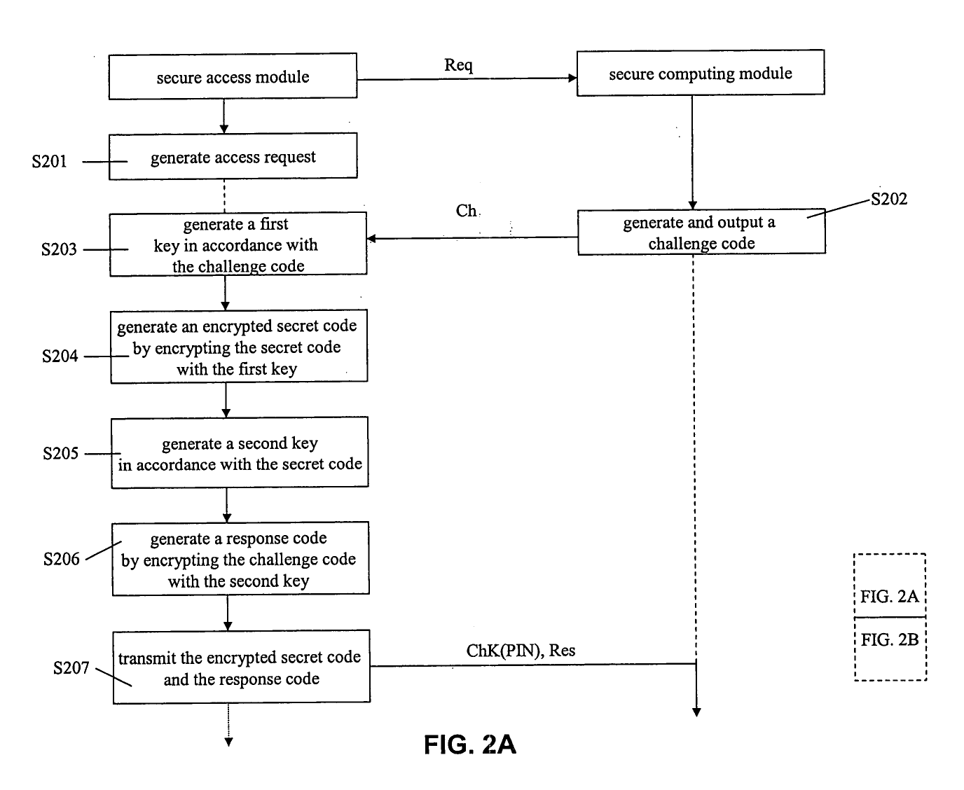

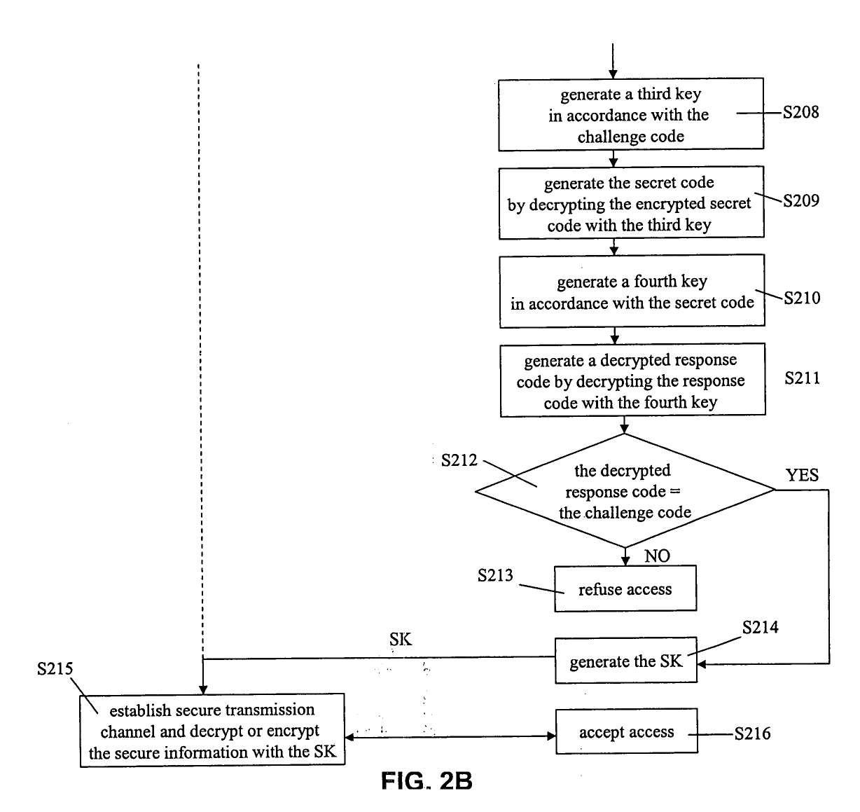

FIGS. 2A and 2B are an operational flow chart diagram showing an exemplary access method for secure information.

First as in step S201, the secure access module 111 generates an access request Req, and furthermore transmits the access request Req to the secure computing module 103. After that, as in step S202, the secure computing module 103 in response to the access request Req generates an access right code hd and in addition generates a challenge code Ch, and furthermore transmits the challenge code Ch to the secure access module 111. In connection with the access request made by the secure access module 111 at this time, all of the information exchanges between the secure access module 111 and the secure computing module 103 may include this access right code hd and perform identification in accordance with this access right code hd.

Next, as in step S203, the secure access module 111 derives a first key (e.g., symmetric key) ChK in accordance with the challenge code Ch and a prescribed algorithm, and furthermore as in step S204, uses the first symmetric key ChK to perform encryption of a secret code PIN in response to the challenge code Ch, whereby to generate an encrypted secret code ChK(PIN). The prescribed algorithm can be a scheme which converts a prescribed character string into a Triple DES encryption key in accordance with the Password-Based Cryptography Standard (PBCS) of the Public-Key Cryptography Standards (PKCS) (PKCS #5).

After that, as in step S205, the secure access module 111 derives a second key, (e.g., a symmetric key) PK in accordance with the secret code PIN and the prescribed algorithm, and furthermore as in step S206, uses the second symmetric key PK to perform encryption of the challenge code Ch, whereby to generate a response code Res. After that, as in step S207, the secure access module 111 transmits the encrypted secret code ChK(PIN) and the response code Res to the secure computing module 103.

Next, as in step S208, the secure computing module 103 derives a third key (e.g., a symmetric key) ChK′ in accordance with the challenge code Ch and the prescribed algorithm, and furthermore as in step S209, uses the third symmetric key ChK′ to perform decryption of the encrypted secret code ChK(PIN), whereby to obtain the secret code PIN. After that, as in step S210, the secure computing module 103 derives a fourth key (e.g., a symmetric key) PK′ in accordance with the secret code PIN and the prescribed algorithm, and furthermore as in step S211, uses the fourth symmetric key PK′ to perform decryption of the response code Res, thereby to obtain a decrypted response-code Res′.

After that, as in step S212, the secure computing module 103 determines whether or not the decrypted response code Res′ is identical to the challenge code Ch, and if the decrypted response code Res′ is different from the challenge code Ch (No in step S212), then as in step S213, the secure computing module 103 refuses access activity of the secure access module 111. But if the decrypted response code Res′ is identical to the challenge code Ch (Yes in step S212), then as in step S214, the secure computing module 103 uses a random number scheme to generate a session symmetric key SK, and furthermore transmits the session key SK to the secure access module 111.

One of ordinary skill in the art, after reading the description of this embodiment, will understand that in other embodiments, the first, second, third and fourth keys may be asymmetric keys, i.e., private and public keys.

After the secure access module 111 receives the session key SK, as in step S215, it then can establish a secure transmission channel with the secure computing module 103, and furthermore it can perform encryption and decryption of secure information transmitted between the secure access module 111 and the secure computing module 103 in accordance with the session key SK, in order to securely access the secure information in the concealed disk partition 102. At this time, the secure computing module 103 can, as in step S216, accept access activity of the secure access module 111. However, after the conclusion of this time of access by the secure access module 111, the secure computing module 103 can set the session key SK to NULL in order to nullify the secure transmission channel between the secure access module 111 and the secure computing module 103.

As stated above, the secure access module 111 also can ensure information security during data transmission between the portable storage device 100 and the computer system 110. Therefore, before the secure computing module 103 transmits the session key SK to the secure access module 111, the secure computing module 103 can derive a fifth key ResK in accordance with the response code Res and the prescribed algorithm, and furthermore use the fifth key ResK to perform encryption of the session key SK, thereby to generate an encrypted session key ResK(SK), and furthermore transmit the encrypted session key ResK(SK) to the secure access module 111. After the secure access module 111 receives the encrypted session key ResK(SK), the secure access module 111 derives the fifth key ResK in accordance with the response code Res and the prescribed algorithm, and performs decryption of the encrypted session key ResK(SK) in accordance with the fifth key ResK, whereby to obtain the session key SK.

In another aspect, in order to convert secure information such as personal secret keys so as to conform to various international key storage token interface standards, one can establish a conversion element (not illustrated in the drawing) in the computer system and use it to perform conversion of secure information acquired from the portable storage device 100 such that the secure information after conversion conforms to international cryptographic token interface standards, such as Cryptographic Service Provider (CSP) led by Microsoft, Cryptographic Token Interface Standard (CTIS) of the Public-Key Cryptography Standards (PKCS) (PKCS #11) led by RSA Laboratories, and Cryptographic Service Provider (CSP) meeting JAVA standard. Of these, the conversion element at least provides functions such as session/thread management, key generation/management, key exchange, data encryption/decryption, hash function, and signature generation/verification.

Therefore, by a portable secure information access system and method based on the present invention, one can securely access secure information in a portable storage medium by means of an effective mechanism. At the same time, if the portable storage medium is lost, the secure information in the concealed disk partition will receive protection and will not end up being stolen.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A portable secure information access system, comprising:
a portable storage device comprising:
a disk partition in which a secure information is recorded; and
a secure computing module; and
a secure access module receiving a session key (SK) from the secure computing module, for encrypting or decrypting the secure information stored in the disk partition in accordance with the SK so as to access the secure information.

2. The portable secure information access system of claim 1, wherein the secure access module receives the SK from the secure computing module in accordance with a challenge-response mechanism.

3. The portable secure information access system of claim 2, wherein the challenge-response mechanism comprises a hand-shaking mechanism.

4. The portable secure information access system of claim 2, wherein, before generating the SK, the secure access module outputs an access request to the secure computing module so as to generate a challenge code; the secure computing module transmits the challenge code to the secure access module; the secure access module outputs an encrypted secret code and a response code which are generated in accordance with the challenge code to the secure computing module; the secure computing module decrypts the encrypted secret code and the response code so as to generate a decrypted response code; and the secure computing module compares the challenge code with the decrypted response code so as to determine whether to generate the SK.

5. The portable secure information access system of claim 4, wherein, before outputting the encrypted secret code and the response code, the secure access module generates a first key in accordance with the challenge code and a prescribed algorithm; generates the encrypted secret code by encrypting a secret code with the first key; generates a second key in accordance with the secret code and the prescribed algorithm; and generates the response code by encrypting the challenge code with the second key.

6. The portable secure information access system of claim 5, wherein the first key and the second key are symmetric keys.

7. The portable secure information access system of claim 5, wherein the prescribed algorithm converts a prescribed character string into a Triple DES encryption key in accordance with Password-Based Cryptography Standard (PBCS) of Public-Key Cryptography Standards (PKCS).

8. The portable secure information access system of claim 4, wherein, before generating the decrypted response code, the secure computing module generates a first key in accordance with the challenge code and a prescribed algorithm; generates a secret code by decrypting the encrypted secret code with the first key; generates a second key in accordance the secret code and the prescribed algorithm; and decrypts the response code with the second key.

9. The portable secure information access system of claim 8, wherein the first key and the second key are symmetric keys.

10. The portable secure information access system of claim 8, wherein the prescribed algorithm converts a prescribed character string into a Triple DES encryption key in accordance with Password-Based Cryptography Standard (PBCS) of Public-Key Cryptography Standards (PKCS).

11. The portable secure information access system of claim 4, wherein the secure computing module generates the challenge code using a random number scheme.

12. The portable secure information access system of claim 4, the secure computing module generates the SK using a random number scheme.

13. The portable secure information access system of claim 4, wherein, before generating the SK, the secure computing module further generates a key in accordance with the response code; encrypts the SK with the key so as to generate an encrypted SK; and transmits the encrypted SK to the secure access module, and the secure access module generates an additional key in accordance with the response code; and decrypts the encrypted SK with the additional key.

14. The portable secure information access system of claim 2, wherein, before receiving the SK, the secure access module outputs an access request to the secure computing module so as to generate a challenge code; the secure computing module transmits the challenge code to the secure access module; the secure access module generates a first symmetric key in accordance with the challenge code and a prescribed algorithm, generates the encrypted secret code by encrypting an secret code with the first symmetric key, generates a second symmetric key in accordance with the secret code and the prescribed algorithm, generates the response code by encrypting the challenge code with the second symmetric key, and outputs the encrypted secret code and the response code to the secure computing module; the secure computing module generates a third symmetric key in accordance with the challenge code and the prescribed algorithm, generates the secret code by decrypting the encrypted secret code with the third symmetric key, generates a fourth symmetric key in accordance the secret code and the prescribed algorithm, and generates a decrypted response code by decrypting the response code with the fourth symmetric key; and the secure computing module compares the challenge code with the decrypted response code so as to determine whether to generate the SK.

15. The portable secure information access system of claim 14, wherein, before generating the SK, the secure computing module further generates a key in accordance with the response code; encrypts the SK with the key so as to generate an encrypted SK; and transmits the encrypted SK to the secure access module, and the secure access module generates an additional key in accordance with the response code; and decrypts the encrypted SK with the additional key.

16. The portable secure information access system of claim 15, wherein the key is substantially similar to the additional key.

17. The portable secure information access system of claim 2, wherein the secure computing module nullifies the SK in response to a conclusion of access of the secure information.

18. The portable secure information access system of claim 1, further comprising a conversion module converting the secure information into a converted secure information, the converted secure information satisfying an international cryptographic token interface standard.

19. The portable secure information access system of claim 1, wherein the disk partition is not detected by an operating system of a computer system and the secure information therein is not accessible by using a file management tool in the computer system.

20. An access method for portable secure information, comprising:
generating a session key (SK) in accordance with a challenge-response mechanism; and
encrypting and decrypting a secure information in accordance with the SK.

21. The access method for portable secure information of claim 20, wherein the challenge-response mechanism comprises a hand-shaking mechanism.

22. The access method for portable secure information of claim 20, wherein the step of generating the SK comprises:
outputting an access request so as to generate a challenge code;
outputting an encrypted secret code and a response code generated in accordance with the challenge code;
decrypting the encrypted secret code and the response code so as to generate a decrypted response code; and
comparing the challenge code with the decrypted response code so as to determine whether to generate the SK.

23. The access method for portable secure information of claim 22, wherein the step of outputting the encrypted secret code and the response code comprises:
generating a first key in accordance with the challenge code and a prescribed algorithm;
generating the encrypted secret code by encrypting a secret code with the first key;
generating a second key in accordance with the secret code and the prescribed algorithm;
generating the response code by encrypting the challenge code with the second key; and
outputting the encrypted secret code and the response code.

24. The access method for portable secure information of claim 23, wherein the first and the second keys are symmetric keys.

25. The access method for portable secure information of claim 23, further comprising converting a prescribed character string into a Triple DES encryption key in accordance with Password-Based Cryptography Standard (PBCS) of Public-Key Cryptography Standards (PKCS).

26. The access method for portable secure information of claim 25, wherein the prescribed algorithm converts a prescribed character string into a Triple DES encryption key in accordance with Password-Based Cryptography Standard (PBCS) of Public-Key Cryptography Standards (PKCS).

27. The access method for portable secure information of claim 22, wherein the step of decrypting the encrypted secret code and the response code so as to generate a decrypted response code comprises:
generating a first key in accordance with the challenge and a prescribed algorithm;
generating a secret code by decrypting the encrypted secret code with the first key;
generating a second key in accordance with the secret code and the prescribed algorithm; and
generating the decrypted response code by decrypting the response code with the second key.

28. The access method for portable secure information of claim 27, wherein the first and the second keys are symmetric keys.

29. The access method for portable secure information of claim 22, wherein the method of generating the SK further comprises:
generating a key in accordance with the response code;
encrypting the SK with the key so as to generate an encrypted SK;
transmitting the encrypted SK;
generating an additional key in accordance with the response code; and
decrypting the encrypted SK with the additional key.

30. The access method for portable secure information of claim 29, wherein the key is substantially equivalent to the additional key.

31. The access method for portable secure information of claim 22, wherein the step of generating the challenge code uses a random number scheme.

32. The access method for portable secure information of claim 22, the step of generating the SK uses a random number scheme.

33. The access method for portable secure information of claim 20, further comprising nullifying the SK in response with a conclusion of access of the secure information.

34. The access method for portable secure information of claim 20, wherein the step of generating the SK comprises:
outputting an access request so as to generate and output a challenge code;
generating a first symmetric key in accordance with the challenge code and a prescribed algorithm;
generating the encrypted secret code by encrypting a secret code with the first symmetric key;
generating a second symmetric key in accordance with the secret code and the prescribed algorithm;
generating the response code by encrypting the challenge code with the second symmetric key;
outputting the encrypted secret code and the response code;
generating a third symmetric key in accordance with the challenge code and the prescribed algorithm;
generating a secret code by decrypting the encrypted secret code with the third symmetric key;
generating a fourth symmetric key in accordance the secret code and prescribed algorithm;
generating the decrypted response code by decrypting the response code with the fourth symmetric key; and
comparing the challenge code with the decrypted response code so as to determine whether to generate the SK.

35. The access method for portable secure information of claim 34, wherein the step of generating the challenge code uses a random number scheme.

36. The access method for portable secure information of claim 34, the step of generating the SK uses a random number scheme.

37. The access method for portable secure information of claim 20, further comprising converting the secure information into a converted secure information, the converted secure information satisfying an international cryptographic token interface standard.

38. A portable storage device, comprising:
a disk partition in which a secure information is recorded; and
a secure computing module, the secure computing module generating a session key (SK) in accordance with a challenge-response mechanism.

39. The portable storage device of claim 38, wherein the challenge-response mechanism comprises a hand-shaking mechanism.

40. The portable storage device of claim 38, wherein the secure computing module generates a challenge code in accordance with an access request; outputs the challenge code; receives an encrypted secret code and a response code which are generated in accordance with the challenge code from the secure computing module; decrypts the encrypted secret code and the response code so as to generate a decrypted response code; and compares the challenge code with the decrypted response code so as to determine whether to generate the SK.

41. The portable storage device of claim 40, wherein, before generating the decrypted response code, the secure computing module generates a first key in accordance with the challenge code and a prescribed algorithm; generates a secret code by decrypting the encrypted secret code with the first key; and generates a second key in accordance the secret code and the prescribed algorithm; and decrypting the response code with the second key.

42. The portable storage device of claim 41, wherein the first and the second keys are symmetric keys.

43. The portable storage device of claim 41, wherein the prescribed algorithm converts a prescribed character string into a Triple DES encryption key in accordance with Password-Based Cryptography Standard (PBCS) of Public-Key Cryptography Standards (PKCS).

44. The portable storage device claim 40, wherein, before generating the SK, the secure computing module further generates an key in accordance with the response code; encrypts the SK with the key so as to generate an encrypted SK; and outputs the encrypted SK.

45. The portable storage device of claim 40, wherein the secure computing module generates the challenge code using a random number scheme.

46. The portable storage device of claim 40, wherein the secure computing module generates the SK using a random number scheme.

47. The portable storage device of claim 38, wherein the secure computing module nullifies the SK in response to a conclusion of access of the secure information.

48. The portable storage device of claim 38, further comprising a conversion module for converting the secure information into a converted secure information, the converted secure information satisfying an international cryptographic token interface standard.

49. The portable storage device of claim 38, wherein the disk partition is not detected by an operating system of a computer system and the secure information therein is not accessible by using a file management tool in the computer system.
